(19) United States
(12) Patent Application Publication
(10) Pub. No.: US 2009/0220648 A1
(43) Pub. Date: Sep. 3, 2009

(54) Nutritional additive for animals

(75) Inventors: Bernt Nilsson, Helsingborg (SE); Lars Persson, Helsingborg (SE)

Correspondence Address: BIRCH STEWART KOLASCH & BIRCH, PO BOX 747, FALLS CHURCH, VA, 22040-0747, US

(73) Assignee: KEMIRA GROW HOW AB, Helsingborg (SE)

(21) Appl. No.: 11/988,157

(22) PCT Filed: Jul. 6, 2006
(86) PCT No.: PCT/SE2006/000851

§ 371 Date: Jan. 2, 2008

(30) Foreign Application Priority Data
Jul. 6, 2005 (SE) 0501565-6

(51) Int. Cl. A23L 1/302; A23L 1/304

(52) U.S. Cl. 426/72; 426/648

(57) ABSTRACT

The present invention relates to a method for producing a co-granulate of mono calcium phosphate and gypsum comprising: providing a mixture of at least burnt lime and gypsum and granulating said mixture with an aqueous solution of phosphoric acid. The invention further relates to a granulate obtainable according to the above method for both compound feed and premixes. Further, according to the invention a mixture of at least CaCO₃ and gypsum is granulated with an aqueous solution of phosphoric acid, wherein the temperature of the mixture during granulation is less than 90° C.

### FIELD OF THE INVENTION

The present invention concerns nutritional supplements for animals. More specifically, the present invention concerns a method of producing a co-granulate of mono calcium phosphate and gypsum, as well as the granulate obtainable by the method.

### BACKGROUND OF THE INVENTION

In order to meet the requirements of domestic animals in regard to nutrients such as phosphorus and calcium, inorganic feed additives, usually calcium phosphates, are included in most fodder mixtures.

In a well balanced fodder the ratio between the calcium content and the phosphorus content is of great importance. The optimal ratio is dependent on the type of fodder, but in most fodder mixtures a high Ca/P ratio (>1) is preferred. Taking this aspect into account MCP (Mono Calcium Phosphate) having a Ca/P ratio as in most commercially available products of 0.7, is not optimal as the sole contributor of calcium in a fodder mixture.

In order to increase the Ca content CaCO₃ is commonly used as a source of calcium due to its low cost. Disadvantages with a feed of CaCO₃, especially for young animals, are however its low calcium availability and high buffering properties, consuming high amounts of the HCl in the stomach of the animal. Another Ca source is gypsum, which have advantage of low buffering properties. In the form of fine particles gypsum has about the same bioavailability as CaCO₃. Dust and flowability problems, however, make fine gypsum particles less attractive as Ca source. If, on the other hand, coarse gypsum particles are used the bioavailability is not sufficient and separation problems occur. Another disadvantage with gypsum is that it has nearly as low water solubility (0.25%) as CaCO₃.

Dicalcium phosphate has the highest Ca/P ratio (1.36) of the commercial available calcium-phosphates. The disadvantage is high buffering properties, the rather low bioavailability and low water solubility of calcium (6%) phosphorous (0%).

Phosphorous is an expensive ingredient and it is therefore of outermost importance to provide fodder mixtures with a high availability of phosphorous for the animals, minimizing excretion with faeces which also cause environmental problems.

Products having a high Ca/P ratio are disclosed in the PCT/SE2003/001401. According to the method disclosed in this publication limestone or dicalcium phosphate is reacted with sulphuric acid. The obtained granulate product includes sulphur which is an essential nutritive substance of which there may be a marginal deficiency in some maintenance rations of feedstuff. The presence of sulphur is necessary above all to ruminants, whose rumen microbes are dependent on the supply of sulphur. This known method however renders some problems, especially when using a high ratio of sulphuric acid, as a large amount of reaction heat is emitted during the process when the calcium compound reacts with the sulphuric acid. A further problem is corrosion by sulphuric acid of the production equipment. The granulation process using sulphuric acid may also result in fragile granules.

U.S. Pat. No. 5,019,148 discloses a method of preparing mineral granules for agriculture comprising particulate mineral solids admixed with a transient fluid adhesive which hardens to form a strong granule binding cement around the mineral solids producing extremely hard granules having possible solubility problems. The fluid adhesive is formed by a coreaction of acids and bases by mechanical shearing at high mixing speeds and temperatures above 100° C. The document does not mention the production of mono calcium phosphate or the solubility of any of the produced products.

### OBJECTS OF THE INVENTION

An object of the present invention is thus to provide a method for producing a granulate containing mono calcium phosphate with a high calcium and phosphorus solubility, a high Ca/P ratio and a high content of S and which process at the same time overcomes the above mentioned problems concerning the methods disclosed in PCT/SE2003/001401 and U.S. Pat. No. 5,019,148.

Another object is to provide a process wherein cheap and easily available gypsum starting materials can be used.

A further object is to provide a granulate with improved physical properties in relation to known gypsum containing products, e.g. the granulate products obtained by the method disclosed in the PCT/SE2003/001401 which are comparatively fragile and the hard products obtained by the method disclosed in the U.S. Pat. No. 5,019,148. In comparison with commercially available gypsum the physical properties are drastically improved.

### SUMMARY OF THE INVENTION

According to the present invention the above objectives are achieved by a method of producing a co-granulate of mono calcium phosphate and gypsum, comprising: providing a mixture of at least burnt lime and gypsum and granulating said mixture with an aqueous solution of phosphoric acid.

The invention further concerns a granulate obtainable according to the above method.

The invention further concerns a method of producing a co-granulate of mono calcium phosphate and gypsum, comprising: providing a mixture of at least CaCO₃ and gypsum; and granulating said mixture with an aqueous solution of phosphoric acid, wherein the temperature of the mixture during granulation is less than 90° C.

### DETAILED DESCRIPTION OF THE INVENTION

The gypsum used in the method according to the invention may be in its anhydride form (CaSO₄) or in its dihydrate form (CaSO₄×2H₂O), or a mixture of these, or in any other available form. However, the dihydrate form of gypsum is preferred. The particle size of the used gypsum may be 0.045-1.5 mm, more preferably 0.045-0.5 and most preferably 0.063-0.25 mm.

According to a preferred embodiment of the invention the granulation liquid is free from sulphuric acid. The concentration of phosphoric acid in the aqueous solution of phosphoric acid is preferably 50-60% by weight.

The phosphoric acid is added in an amount sufficient to give the final product a phosphorous content of between 4 and 20 wt %, preferably between 5 and 15 wt %. The gypsum is added in an amount sufficient to give the final product a sulphur content of 1-15 wt %, preferably 3-13 wt %.

According to one embodiment the granulation process includes only burnt lime, gypsum phosphoric acid and water. However in an alternative embodiment the burnt lime could be replaced completely or partially by lime stone. Additionally the granulation process could include other calcium sources such as slaked lime [Ca(OH₂)], dicalcium phosphate (CaHPO₄).

As regards additives, which may be used in the inventive granulation method, NaCl should be especially mentioned. NaCl is a necessary highly palatable fodder ingredient and it is an especial advantage that NaCl can be used in the present granulation process. The presence of NaCl in the granulation process constitutes a valuable granulation aid when products having a very high Ca/P ration are of interest. By using NaCl dissolved in the granulation liquid, a co-granulate including up to 12% NaCl can be obtained. Furthermore, preliminary experiments indicate that the use of NaCl in the granulation process is a special advantage when co-granulates having a comparatively high calcium content (such as between 19% and 22%), a comparatively high sulphur content (such as between 10 and 13) and a comparatively low phosphorus content (such as between 4 and 10) are of interest. These products, which are distinguished by good water solubility and high Ca/P ratio (above 1.4 preferably above 1.7 and most preferably above 2.0, make such products especially valuable in comparison not only in comparison with CaCO₃ but also in comparison with product prepared by the method disclosed in the PCT/SE2003/001401. In the obtained products the amount of NaCl preferably varies between 1 and 10% by weight.

In granulation, the components of the composition can be mixed in different ways, and the granulation liquid and the composition can be added to a granulation device in different ways, known to the man skilled in the art. Water may be sprinkled, such as from a nozzle, over the mixture during granulation in order to control the granulation liquid to reaction/granulation efficient level and compensate the water loss from the production process. In fact, excellent results were obtained by sprinkling water onto the granulation mixture during granulation. The water is preferably sprinkled at a rate of 100-300 l/ton product during granulation.

The used aqueous solution of phosphoric acid may be pre-heated, preferably to at least 30° C., most preferably to at least 40° C.

The temperature of the mixture during granulation may be less than 90° C., preferably less than 50° C., most preferably less than 40° C.

The speed of the granulation vessel may be 5-40 rpm, preferably 10-30 rpm and preferably no agitator or agitation is used.

The nutritional supplement co-granulate obtained according to the inventive method includes calcium phosphates in an amount of 17-80% by weight and calcium sulphates. At least 90% by weight of the calcium phosphates is in the form of mono calcium phosphate, Ca(H₂PO₄). The co-granulate is furthermore distinguished by a Ca/P ratio above 1.4 preferably above 1.7 and most preferably above 2.0. Up to 12% by weight of NaCl, may be included in the co-granulate. So far interesting results have been obtained with NaCl in amounts above 1% and preferably between 5 and 10% by weight. Other elements which may be present in the co-granulate are up to 4% by weight of CaCO₃, up to 2%, preferably between 1 and 1.5% by weight of free phosphoric acid, and up to 5% by weight Mg. The phosphorus content normally varies between 3 and 20% by weight and the sulphur content between 1 and 15% by weight. Interesting products have a calcium content above 17% (eg 17-22%), a phosphorus content of 4 and 10% by weight and a sulphur content of 10-13% by weight. Other distinguishing features of the products are the relative water solubility (Jensen tested pH 7) which for P should be at least 90% by weight and for Ca at least 75% by weight.

The particle size of the obtained granules is preferably 0.25-2.0 mm.

The abrasion strength of the co-granulate obtained according to the inventive method may be below 3%, preferably below 2%.

The co-granulate produced and obtained according to the method of the invention may be admixed with vitamins and trace minerals to form a premix.

Preferred embodiments will now be described by means of some examples and series of experiments. These should not be considered limiting to the scope of the present invention.

### Example 1

Four different granulated fodder mixtures were prepared. The constituents for the different mixtures are shown in table 1. Fodder mixture 2 was prepared according to the method of the invention.

The trials were performed in a drum granulator, except for mixture number 4 which was prepared in a laboratory scale trial. The acids for mixture 1 and 3 were mixed in an open vessel equipped with a steam heater and an agitator. The used sulphuric acid had a concentration of 95%, and the used phosphoric acid had a concentration of 57%, calculated as P₂O₅. The acids were preheated to 40° C. The dosage of acids into the granulator was controlled by a flow meter and a pump. The dosage of CaO, CaCO₃ and gypsum (dihydrate, particle size 0.063-0.25 mm) was controlled by a weighing belt. The speed of the granulation drum was 22 rpm (no agitator was used) and the temperature during granulation was kept below 40° C. The retention time in the granulator was about 5 minutes for fodder mixture 2 and about 9 minutes for mixture 1 and 3. Water was added during granulation at a rate of 100-300 l/ton product.

The granulates from the different trials were analysed for content of Ca, P and S as well as the solubility of Ca and P. Abrasion test were performed to assess granule strength and predict dusting problems. The results of the analysis are shown in table 2.

TABLE 1
Constituents for trial 1-6.

| Trial | 1 | 2¹ | 3 | 4² |
|---|---|---|---|---|
| CaO/CaCO₃ (%) | 60/40 | 100/0 | 100/0 | 0/100 |
| H₂SO₄/CaSO₄*2H₂O (%) | 100/0 | 0/100 | 100/0 | 0/100 |
| P₂O₅/H₂O (%) | 57/43 | 57/43 | 57/43 | 57/43 |
| NaCl | | | X | X |
| H₂O, extra dosing | X | X | X | X |

¹Produced according to the method of the invention.
²Results from laboratory scale trial.

TABLE 2
Analysis of products obtained in trial 1-4.

| | Trial | | | |
|---|---|---|---|---|
| XRF | 1 | 2¹ | 3 | 4² |
| Ca (%) | 18.7 | 17.9 | 19.8 | 19.1 |
| P (%) | 14.9 | 14.3 | 14.9 | 13.3 |
| S (%) | 6.8 | 7.7 | 6.8 | 7.6 |
| Ca/P | 1.26 | 1.25 | 1.33 | 1.44 |
| P, rel water soluble | 93 | 98 | 84 | 85 |
| (%)³ | | | | |
| Ca, rel water soluble | 83 | 78 | 61 | 54 |
| (%)³ | | | | |
| PH, 1% solution | 4.8 | 3.9 | 4.7 | — |
| H₃PO₄, free (%) | 1.3 | 2.9 | 1.3 | <0.1 |
| Abrasion strength (%) | 5 | 1.3 | 7.5 | — |
| Heat evolved | 177 | 130 | 263 | — |
| (Mcal/ton product)⁴ | | | | |
| Diff. MCP⁵ | | −47 | | −263 |
| (Mcal/ton product) | | | | |

¹Produced according to the method of the invention.
²Results from laboratory scale trial.
³% compared to total amount obtained from XRF analysis.
⁴Calculated values
⁵Evolved heat in comparison with the method disclosed in the PCT/SE2003/001401
— not measured/calculated

### Abrasion Test

The abrasion test was performed by grinding the granules. The formed fraction of fine particles was sieved and weighed. The abrasion strength was calculated as a percentage of the weight of fine particles relative the initial total weight of the granules. The abrasion value should preferably be below 3% of fines <250μ in order to avoid dusting problems after storage and handling.

### XRF (X-Ray-Fluorescence)

XRF analysis entails exciting atoms in a sample material by X-rays emitted from an X-ray tube or a radioisotope. The element specific X-ray fluorescence signals, which are emitted by the atoms, are measured (wavelength, intensity) in a detector. The radiation intensity of each element signal, which is proportional to the concentration of the element in the sample, is recalculated internally from a stored set of calibration curves and may be shown directly in concentration units. In table 2 the concentration of each element is expressed as a percentage of the total content of Ca, P and S.

### Water Soluble Calcium

The analysis entails extracting the sample in water during 30 minutes. The Ca content is then analyzed in a filtered sample by the ICP method. ICP or “Inductively coupled plasma spectroscopy” is a method where an argon plasma, a very hot flame-like source, is created by pumping energy into a stream of argon through high-energy radio waves and a sample solution is aspirated into it. The sample will emit element specific energy or radiation which is detected and the data is analysed in a computer.

### Water Soluble Phosphorous

### Method: Regulation (EC) No2003/2003 3:1.6

The analysis entails extracting the sample in water during 30 minutes. The P content is then analysed in a filtered sample by the feed phosphate standard Quimociac method. This gravimetric method is based on precipitation of P as quinoline molybdophosphate by adding a quimociac reagent solution. The solubility is calculated after filtration, washing, drying and weighing the precipitate.

As can be seen in Table 2 excellent properties of the granulates are obtained when the method according to the invention using CaO and H₃PO₄ is used. The use of CaCO₃ instead of CaO results in lower solubilities of Ca and P for the obtained products. It is thus through the present invention possible to produce a stable granulated fodder additive with high Ca and P solubility and a Ca/P ratio above 1 without the formation of large amounts of reaction heat.

### Example 2

### Jensen Method

### Based on Published Findings

Jensen tests, simulating the conditions inside the intestines of a pig, were conducted on granulates produced according to the invention and, for comparison purposes, produced by the use of CaCO₃, sulphuric acid as well as on pure MCP. The tests were performed by performing a 0.5 hour incubation at both pH 7.0 and pH 2.5. The relative solubility of Ca and P were measured. The results are given in Table 3.

TABLE 3

| Components in the granulating process (g) | | | | | | Jensen test | | Jensen test | |
|---|---|---|---|---|---|---|---|---|---|
| Burnt | | | | | | pH 7.0 | | pH 2.5 | |
| Lime | NaCl | CaCO₃ | P-Acid | Gypsum | S-Acid | % Ca | % P | % Ca | % P |
| 50 | | 0 | 216 | 120 | 0 | 92.0 | 90.0 | 94.3 | 97.0 |
| 50 | | 0 | 216 | 60 | 36 | 94.0 | 94.8 | 94.3 | 95.4 |
| 0 | | 98 | 216 | 170 | 0 | 81.2 | 80.1 | 96.2 | 95.8 |
| 41 | 50 | 0 | 97 | 783 | 0 | ** | ** | ** | ** |
| 39 | 100 | 0 | 92 | 742 | 0 | ** | ** | ** | ** |

| | | | | |
|---|---|---|---|---|
| Commercial mono calcium phosphate | 65.9 | 77.5 | 94.5 | 94.2 |

The granulates of the present invention, comprising burnt lime and phosphoric acid, have solubilities in the same range as, or higher than, pure MCP, proving again the suitability of the present invention for production of fodder.

The following table 4 discloses the buffering capacity and water soluble calcium of the products according to the present invention and known products

TABLE 4

| | | water soluble |
|---|---|---|
| Product | mekvH⁺/kg sample | calcium % |
| CaCO₃ | 14850 | <0.1 (7 ppm) |
| CaSO₄ | 50 | 0.25 |
| DCP* | 5920 | <0.1 |
| NaCl | 60 | — |
| Trial product 2 | 350 | 78 |
| Trial product 5 | 230 | ** |
| Trial product 6 | 240 | ** |

TABLE 5

| | sample | | | | | | | |
|---|---|---|---|---|---|---|---|---|
| Cal. | | | | | | | % CaSO₄ | % |
| Val. | % S | % Ca | % P | % Na | Ca/P | % MCP | *2H₂O | NaCl |
| * | 2 | 16.7 | 22.0 | | 0.76 | 89.3 | 10.7 | |
| * | 4 | 17.50 | 19.30 | | 0.91 | 78.5 | 21.5 | |
| * | 6 | 18.29 | 16.66 | | 1.10 | 67.7 | 32.3 | |
| * | 8 | 19.09 | 14.01 | | 1.36 | 57.0 | 43.0 | |
| * | 10 | 19.88 | 11.37 | | 1.75 | 46.2 | 53.8 | |
| * | 12 | 20.68 | 8.72 | | 2.37 | 35.5 | 64.5 | |
| * | 15 | 21.4 | 4 | | 5.35 | 17.6 | 82.4 | |
| 5 ** | 14.25 | 20.33 | 3.8 | 1.97 | 5.35 | 16.7 | 78.3 | 5 |
| 6 ** | 13.5 | 19.26 | 3.6 | 3.93 | 5.35 | 15.8 | 74.2 | 10 |

* Calculated values
** Trial products 5 and 6 are the trial products from table 1 and 3
*** Ca (H₂PO₄)₂*H₂O and gypsum calculated as CaSO₄*2H₂O

The calculated values should be seen only as guidelines for balance of elements in the granulate, since the products always will contain a small part of non-reacted chemicals and free water. The distribution of MCP/gypsum will be a result of the drying procedure, and can due to this differ in crystal water.

1. Method of producing a nutritional supplement for animals comprising a co-granulate of mono calcium phosphate and gypsum, comprising:
providing a mixture of at least burnt lime and gypsum, wherein the gypsum is added in an amount sufficient to give the final product a sulphur content of 3-15 wt %; and
granulating said mixture with an aqueous solution of phosphoric acid, wherein the temperature of the mixture during granulation is less than 90° C.

2. Method according to claim 1, wherein the concentration of phosphoric acid in the aqueous solution is 50-60% by weight.

3. Method according to claims 1 or 2, wherein the gypsum is present in its anhydride or dihydrate form or is a mixture thereof.

4. Method according to claim 1, wherein the particle size of the gypsum is 0.045-1.5 mm, preferably 0.045-0.5 mm.

5. Method according to claim 1, wherein the phosphoric acid is added in an amount sufficient to give the final product a phosphorous content of 4-20 wt %, preferably 5-15 wt %.

6. Method according to claim 1, wherein water is sprinkled over the mixture during granulation.

7. Method according to claim 6, wherein water is sprinkled at a rate of 100-300 l/ton during granulation.

8. Method according to claim 1, wherein the temperature of the mixture during granulation is less than 50° C., preferably less than 40° C.

9. Method according to claim 1, wherein the obtained co-granulate is mixed with vitamins and trace minerals to form a premix.

10. A nutritional supplement co-granulate comprising calcium phosphates in an amount of 17-80% of the co-granulate and calcium sulphates, said co-granulate having a Ca/P ratio above 1.4 preferably above 1.7 and most preferably above 2.0.

11. A co-granulate according to claim 10, characterized in that at least 90% by weight of the calcium phosphates is in the form of mono calcium phosphate, Ca(H₂PO₄).

12. A co-granulate according to claim 11 characterized in that it includes up to 12% by weight of NaCl, preferably 5-10% by weight of NaCl.

13. A co-granulate according to claim 12 further comprising up to 4% by weight of CaCO₃, up to 2%, preferably between 1 and 1.5% by weight of free phosphoric acid, up to 5% by weight of Na or Mg.

14. Co-granulate according to any one of the claims 10-13 further characterized in:
a phosphorus content of 3-20% by weight,
a sulphur content of 1-15% by weight,
a calcium content of 17-22% by weight,
a P relative water solubility of at least 90% by weight and
a Ca relative water solubility of at least 75% by weight.

15. Co-granulate according to claim 14, characterized in:
a phosphorus content of 4 and 10% by weight,
a sulphur content of 10-13% by weight, and
a calcium content of 18-22% by weight.

16. A co-granulate obtainable according to claim 1.

17. Co-granulate according to claim 16 admixed with vitamins and trace minerals.

18. Method of producing a nutritional supplement for animals comprising a co-granulate of mono calcium phosphate and gypsum, comprising:
providing a mixture of at least CaCO₃ and gypsum, wherein the gypsum is added in an amount sufficient to give the final product a sulphur content of 3-15 wt %; and
granulating said mixture with an aqueous solution of phosphoric acid, wherein the temperature of the mixture during granulation is less than 90° C.

19. (canceled)
